(19) United States
(12) Patent Application Publication
(10) Pub. No.: US 2007/0052908 A1
(43) Pub. Date: Mar. 8, 2007

(54) Liquid crystal display and method for manufacturing the same

(75) Inventor: Yang-Gyu Jang, Cheonan-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/510,346

(22) Filed: Aug. 25, 2006

(30) Foreign Application Priority Data
Sep. 2, 2005 (KR) 10-2005-0081632

(51) Int. Cl. G02F 1/1339

(52) U.S. Cl. 349/153

(57) ABSTRACT

A liquid crystal display includes first and second panels facing each other, a sealant disposed between the first and second panels and formed along a perimeter of one of the two panels, a plurality of risings disposed on a same panel as the sealant and formed along a perimeter of a display region enclosed by the sealant, and a liquid crystal layer enclosed by the sealant and formed between the first and second panels.

### CROSS-REFERENCE TO RELATED APPLICATION

This application claims priority to Korean Patent Application No. 10-2005-0081632 filed on Sep. 02, 2005, the contents of which are incorporated herein by reference in their entireties.

### BACKGROUND OF THE INVENTION

(a) Technical Field

The present disclosure relates to a liquid crystal display and a method for manufacturing the same, and more particularly to a liquid crystal display having a uniform cell gap and a method for manufacturing the same.

(b) Discussion of the Related Art

A liquid crystal display (LCD) is a widely-used flat panel display. The LCD may include two panels provided with field-generating electrodes such as pixel electrodes and a common electrode, and a liquid crystal (LC) layer interposed therebetween. The LCD displays images by applying voltages to the field-generating electrodes to generate an electric field in the LC layer, which determines orientations of LC molecules in the LC layer to adjust polarization of incident light. The LCD may include a plurality of pixel electrodes arranged in a matrix on one panel and a common electrode disposed on the other panel. The image display of the LCD can be accomplished by applying individual voltages to the respective pixel electrodes. For the application of the individual voltages, a plurality of three-terminal thin film transistors (TFTs) are connected to the respective pixel electrodes, and a plurality of gate lines for transmitting signals for controlling the TFTs and a plurality of data lines for transmitting voltages to the pixel electrodes are provided on a panel.

The LCD can include a plurality of spacers formed between the two panels for supporting the two panels, thereby forming a cell gap between the two panels. The LCD can further include a sealant for combining the two panels and sealing the liquid crystal layer therein.

The liquid crystal may flow to the edges of the two panels, for example, along a perimeter of the panels, resulting in a non-uniform distribution of the liquid crystal such that the cell gap may be non-uniform. The liquid crystal may be contaminated by directly contacting an unhardened sealant in an assembly process for combining the two panels. The liquid crystal may be damaged by ultraviolet rays when the sealant is hardened by the ultraviolet rays.

Thus, there is a need for a liquid crystal display that can control flow of the liquid crystal to maintain a uniform cell gap and a method for manufacturing the same. There is also a need for a liquid crystal display capable of preventing the contamination of the liquid crystal.

### SUMMARY OF THE INVENTION

According to an embodiment of the present invention, a liquid crystal display includes first and second panels facing each other, a sealant disposed between the first and second panels and formed along a perimeter of one of the two panels, a rising disposed on the same layer as the sealant formed on and formed along at least a portion of the perimeter of a display region enclosed by the sealant, and a liquid crystal layer enclosed by the sealant and disposed between the first and second panels.

A height of the rising may be less than a height of the sealant, and the rising may include a plurality of discontinuous protrusions.

The rising may include a first rising and a second rising formed between the first rising and the sealant.

The rising may comprise one of acrylic resin, epoxy resin, acrylic-epoxy resin, or phenol resin.

The liquid crystal display may further include a plurality of spacers disposed between the first and second panels.

According to an embodiment of the present invention, a liquid crystal display includes first and second panels facing each other, a sealant disposed between the first and second panels and formed along a perimeter of one of the two panels, a rising disposed on the same layer as the sealant formed on and formed along at least portion of the perimeter of a display region enclosed by the sealant, a plurality of spherical spacers disposed between the first and second panels, and a liquid crystal layer enclosed by the sealant and formed between the first and second panels.

A height of the rising may be less than a height of the sealant, and the rising may include a plurality of discontinuous protrusions.

The rising may include a first rising and a second rising formed between the first rising and the sealant.

The rising may include a thermal hardening material or a light hardening material.

According to an embodiment of the present invention, a method of producing a liquid crystal display includes forming first and second panels having a plurality of thin films, forming a rising on one of the first and second panels, hardening the rising, forming a sealant enclosing the rising on one of the first and second panels, assembling the first panel and the second panel, and hardening the sealant.

A height of the rising may be less than a height of the sealant.

The method may further include forming an alignment layer on a panel before the formation of the rising.

The rising may include a first rising and a second rising formed between the first rising and the sealant, and the hardening of the rising and the sealant may be executed by using one of light irradiation and thermal irradiation.

Forming the first panel may include forming a gate line on a first substrate, forming a semiconductor on the gate line, forming a data line intersecting the gate line and a drain electrode, and forming a pixel electrode connected to the drain electrode.

The method may further include depositing a liquid crystal material on the first panel after the formation of the first panel.

The method may further include dispersing a plurality of spacers on the first panel after forming the first panel.

Forming the second panel may include forming a light blocking member on a second substrate, forming a color filter on the second substrate, and forming a common electrode on the light blocking member and the color filter.

The first and second panels may be assembled in a vacuum atmosphere.

### BRIEF DESCRIPTION OF THE DRAWINGS

Exemplary embodiments of the present disclosure can be understood in more detail from the following description taken in conjunction with the accompanying drawings of which:

FIG. 1 is a perspective view of a liquid crystal display according to an embodiment of the present invention;

FIG. 2 is a layout view of a liquid crystal display according to an embodiment of the present invention;

FIG. 3 is a sectional view of an LCD taken along the line III-III in FIG. 2;

FIG. 4 is a layout view of a TFT array panel for illustrating a manufacturing method of a liquid crystal display according to an embodiment of the present invention;

FIG. 5 is a sectional view of a TFT array panel taken along the line V-V in FIG. 4;

FIG. 6 is a layout view of a TFT array panel for illustrating a manufacturing process of a liquid crystal display according to an embodiment of the present invention;

FIG. 7 is a sectional view of a TFT array panel taken along the line VII-VII in FIG. 6;

FIG. 8 is a layout view of a TFT array panel for illustrating a manufacturing process of a liquid crystal display according to an embodiment of the present invention;

FIG. 9 is a sectional view of a TFT array panel taken along the line IX-IX in FIG. 8;

FIG. 10 is a sectional view of a TFT array panel for illustrating a process for depositing liquid crystal;

FIGS. 11 to 14 are sectional views of a common electrode panel for illustrating a manufacturing method of a liquid crystal display according to an embodiment of the present invention; and

FIGS. 15A to 15D are layout views of a liquid crystal display according to embodiments of the present invention.

### DETAILED DESCRIPTION OF EXEMPLARY EMBODIMENTS

Exemplary embodiments of the present invention will be described in more detail with reference to the accompanying drawings. The present invention may, however, be embodied in many different forms and should not be construed as limited to the embodiments set forth herein.

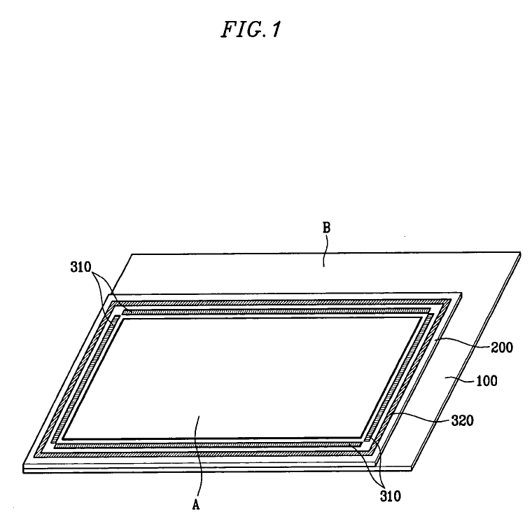

A liquid crystal display according to an embodiment of the present invention is described with reference to FIGS. 1 to 3.

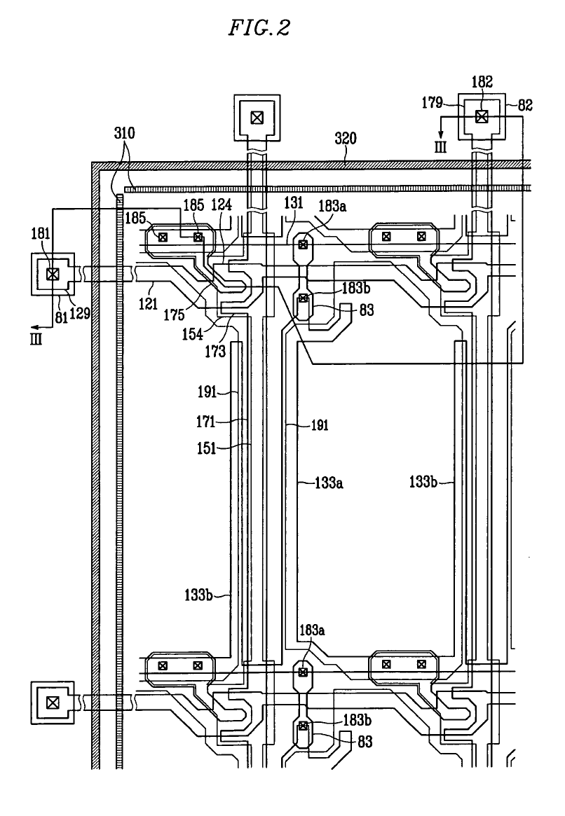

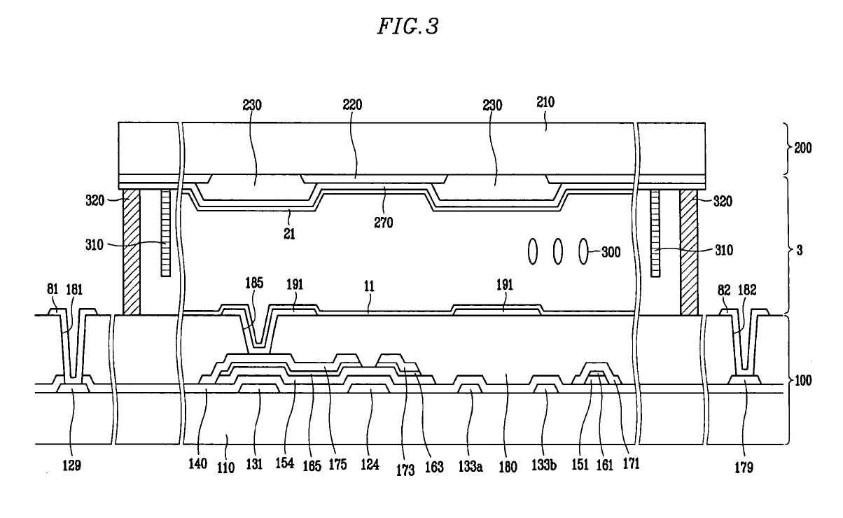

FIG. 1 is a perspective view of a liquid crystal display according to an embodiment of the present invention. FIG. 2 is a layout view of a liquid crystal display according to an embodiment of the present invention. FIG. 3 is a sectional view of an LCD taken along the line III-III in FIG. 2.

An LCD according to an embodiment of the present invention includes a TFT array panel 100, a common electrode panel 200 opposite to the TFT array panel 100, and an LC layer 3 having LC molecules disposed between the two panels 100 and 200. The LCD includes a display region A for displaying images and a pad region B wherein connections are made to external driving circuits.

A TFT array panel 100 according to an embodiment of the present invention is described with reference to FIGS. 1 to 3.

A plurality of gate lines 121 and a plurality of storage electrode lines 131 are formed on an insulating substrate 110 comprising, for example, transparent glass or plastic.

The gate lines 121 transmit gate signals and extend substantially in a transverse direction. Each of the gate lines 121 includes a plurality of gate electrodes 124 projecting downwardly and an end portion 129 having a large enough area for contact with another layer or an external driving circuit. A gate driving circuit (not shown) for generating the gate signals may be mounted on a flexible printed circuit (FPC) film (not shown), which may be attached to the substrate 110, directly mounted on the substrate 110, or integrated with the substrate 110. The gate lines 121 may extend to be connected to a driving circuit that may be integrated with the substrate 110.

The storage electrode lines 131 are supplied with a predetermined voltage, and each of the storage electrode lines 131 includes a stem extending substantially parallel to the gate lines 121 and a plurality of pairs of storage electrodes 133a and 133b branched from the stem. Each of the storage electrode lines 131 is disposed between two adjacent gate lines 121, and the stem is close to one of the two adjacent gate lines 121. Each of the storage electrodes 133a and 133b has a fixed end portion connected to the stem and a free end portion disposed opposite thereto. The fixed end portion of the storage electrode 133b has a large area, and the free end portion thereof is bifurcated into a linear branch and a curved branch. According to embodiments of the present invention, the storage electrode lines 131 may have various shapes and arrangements.

The gate lines 121 and the storage electrode lines 131 may comprise, for example, an Al-containing metal such as Al and an Al alloy, a Ag-containing metal such as Ag and a Ag alloy, a Cu-containing metal such as Cu and a Cu alloy, a Mo-containing metal such as Mo and a Mo alloy, Cr, Ta, or Ti. In an embodiment of the present invention, the gate lines 121 and the storage electrode lines 131 may have a multi-layered structure including two conductive films (not shown) having different physical characteristics. One of the two films may comprise a low resistivity metal such as, for example, an Al-containing metal, a Ag-containing metal, and a Cu-containing metal for reducing signal delay or voltage drop. The other film may comprise, for example, a Mo-containing metal, Cr, Ta, or Ti, which have good physical, chemical, and electrical contact characteristics with other materials such as, for example, indium tin oxide (ITO) or indium zinc oxide (IZO). Examples of the combination of the two films can be a lower Cr film and an upper Al alloy film and a lower Al film and an upper Mo film. According to embodiments of the present invention, the gate lines 121 and the storage electrode lines 131 may comprise various metals or conductors.

The lateral sides of the gate lines 121 and the storage electrode lines 131 can be inclined with respect to a surface of the substrate 110, and the inclination angle thereof ranges about 30 degrees to about 80 degrees.

A gate insulating layer 140 comprising, for example, silicon nitride (SiNx) or silicon oxide (SiOx) can be formed on the gate lines 121 and the storage electrode lines 131.

A plurality of semiconductor stripes 151 comprising, for example, hydrogenated amorphous silicon (abbreviated to “a-Si”) or polysilicon can be formed on the gate insulating layer 140. The semiconductor stripes 151 extend substantially in the longitudinal direction and become wide near the gate lines 121 and the storage electrode lines 131 such that the semiconductor stripes 151 cover large areas of the gate lines 121 and the storage electrode lines 131. Each of the semiconductor stripes 151 includes a plurality of projections 154 branched toward the gate electrodes 124.

A plurality of ohmic contact stripes and islands 161 and 165 are formed on the semiconductor stripes 151. The ohmic contact stripes and islands 161 and 165 may comprise, for example, n+ hydrogenated a-Si heavily doped with an N-type impurity such as phosphorous. The ohmic contact stripes and islands 161 and 165 may comprise, for example, silicide. Each ohmic contact stripe 161 includes a plurality of projections 163. The projections 163 and the ohmic contact islands 165 can be located in pairs on the projections 154 of the semiconductor stripes 151.

The lateral sides of the semiconductor stripes 151 and the ohmic contact stripes and islands 161 and 165 are inclined with respect to the surface of the substrate 110, and the inclination angles thereof can be in a range of about 30 degrees to about 80 degrees.

A plurality of data lines 171 and a plurality of drain electrodes 175 are formed on the ohmic contact stripes and islands 161 and 165 and the gate insulating layer 140.

The data lines 171 transmit data signals and extend substantially in the longitudinal direction to intersect the gate lines 121. Each data line 171 also intersects the storage electrode lines 131 and can be disposed between adjacent pairs of storage electrodes 133a and 133b. Each data line 171 includes a plurality of source electrodes 173 projecting toward the gate electrodes 124 and wherein the plurality of source electrodes 173 are curved similar to a crescent shape. Each data line 171 also includes an end portion 179 having a large enough area for contact with another layer or an external driving circuit. A data driving circuit (not shown) for generating the data signals may be mounted on an FPC film (not shown), which may be attached to the substrate 110, directly mounted on the substrate 110, or integrated with the substrate 110. The data lines 171 may extend to be connected to a driving circuit that may be integrated with the substrate 110.

The drain electrodes 175 are separated from the data lines 171 and disposed opposite the source electrodes 173 with respect to the gate electrodes 124.

The gate electrode 124, the source electrode 173, and the drain electrode 175 along with the projection 154 of a semiconductor stripe 151 form a TFT having a channel formed in the projection 154 disposed between the source electrode 173 and the drain electrode 175.

The data lines 171 and the drain electrodes 175 may comprise a refractory metal such as, for example, Cr, Mo, Ti, Ta or alloys thereof. According to an embodiment of the present invention, the data lines 171 and the drain electrodes 175 may have a multilayered structure including a low-resistivity film (not shown) and a good-contact film (not shown). An example of the combination is a lower Mo film, an intermediate Al film, and an upper Mo film. According to an embodiment of the present invention, a lower Cr film and an upper Al—Nd alloy film or a lower Al film and an upper Mo film can be used. According to embodiments of the present invention, the data lines 171 and the drain electrodes 175 may comprise various metals or conductors.

The data lines 171 and the drain electrodes 175 have inclined edge profiles, and the inclination angles thereof range about 30 degrees to about 80 degrees.

A passivation layer 180 is formed on the data lines 171 and the drain electrodes 175, and the exposed portions of the semiconductor stripes 151. The passivation layer 180 may comprise, for example, an inorganic or organic insulator, and the passivation layer 180 may have a flat top surface. Examples of the inorganic insulator material include silicon nitride and silicon oxide. The organic insulator may have photosensitivity and a dielectric constant of less than about 4.0. The passivation layer 180 may include a lower film of an inorganic insulator and an upper film of an organic insulator such that the good insulating characteristics of the organic insulator can be used while preventing the exposed portions of the semiconductor stripes 151 from being damaged.

The passivation layer 180 has a plurality of contact holes 182 and 185 exposing the end portions 179 of the data lines 171 and the drain electrodes 175, respectively. The passivation layer 180 and the gate insulating layer 140 have a plurality of contact holes 181 exposing the end portions 129 of the gate lines 121, a plurality of contact holes 183a exposing portions of the storage electrode lines 131 near the fixed end portions of the storage electrodes 133b, and a plurality of contact holes 183b exposing the linear branches of the free end portions of the storage electrodes 133b.

A plurality of pixel electrodes 191, a plurality of overpasses 83, and a plurality of contact assistants 81 and 82 comprising, for example, a transparent conductor such as ITO or IZO, or a reflective conductor such as Ag, Al, Cr, or alloys thereof are formed on the passivation layer 180.

The pixel electrodes 191 are physically and electrically connected to the drain electrodes 175 through the contact holes 185 such that the pixel electrodes 191 receive data voltages from the drain electrodes 175. The pixel electrodes 191 receiving the data voltages generate electric fields in cooperation with a common electrode 270 of the opposing common electrode panel 200 receiving a common voltage. The generated electric fields determine the orientations of liquid crystal 300 of the liquid crystal layer 3 disposed between the two panels 100 and 200. The pixel electrode 191 and the common electrode 270 form a liquid crystal capacitor, which stores applied voltages after the TFT turns off.

The pixel electrode 191 overlaps a storage electrode line 131 including storage electrodes 133a and 133b. The pixel electrode 191, the drain electrode 175 connected thereto, and the storage electrode line 131 form a storage capacitor, which enhances the voltage storing capacity of the liquid crystal capacitor.

The contact assistants 81 and 82 are connected to the end portions 129 of the gate lines 121 and the end portions 179 of the data lines 171 through the contact holes 181 and 182, respectively. The contact assistants 81 and 82 protect the end portions 129 and 179 and enhance the adhesion between the end portions 129 and 179 and external devices.

The overpasses 83 cross over the gate lines 121 and are connected to the exposed portions of the storage electrode lines 131 and the exposed linear branches of the free end portions of the storage electrodes 133b through the contact holes 183a and 183b, respectively. The contact holes 183a and 183b are disposed opposite each other with respect to the gate lines 121. The storage electrode lines 131 including the storage electrodes 133a and 133b along with the overpasses 83 can be used for repairing defects in the gate lines 121, the data lines 171, or the TFTs.

A first alignment layer 11 is formed on the passivation layer 180 of the display region A. The first alignment layer 11 may comprise an insulating material such as, for example, polyimide.

The common electrode panel 200 is described with reference to FIGS. 1 to 3.

A light blocking member 220 called a black matrix for preventing light leakage is formed on an insulating substrate 210 comprising, for example, transparent glass. The light blocking member 220 may include a plurality of openings (not shown) that face the pixel electrodes 191, and the light blocking member may have substantially the same planar shape as the pixel electrodes 191. The light blocking member 220 may include linear portions corresponding to the data lines 171 and the gate lines 121, and other portions corresponding to the TFTs.

A plurality of color filters 230 are formed on the substrate 210, and are disposed substantially in the areas enclosed by the light blocking member 220. The color filters 230 may extend substantially in the longitudinal direction along the pixel electrodes 191. The color filters 230 may represent one of the primary colors such as red, green, and blue.

The common electrode 270 is formed on the color filters 230. The common electrode 270 may comprise a transparent conductive material such as, for example, ITO and IZO.

A second alignment layer 21 is formed on the common electrode 270 of the display region A. The second alignment layer 21 may comprise an insulating material such as, for example, polyimide.

A plurality of risings 310 are formed on the common electrode 270. The risings 310 enclose the display region A and are arranged outside the display region A. The risings 310 may have various shapes including a continuous protrusion or a plurality of protrusions that are discontinuous according to embodiments of the present invention, and the plurality of risings 310 may be one.

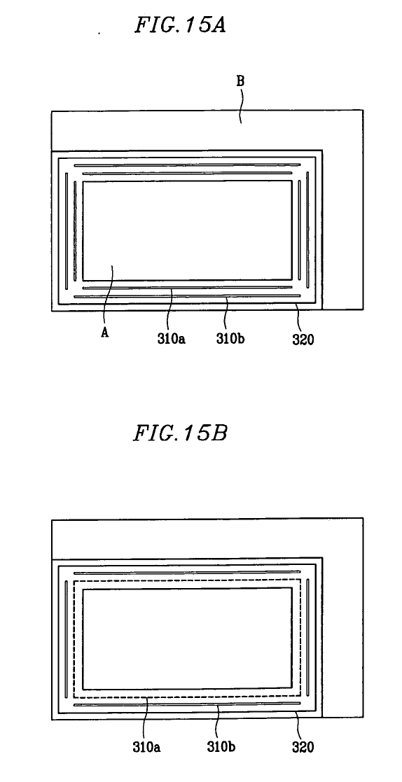

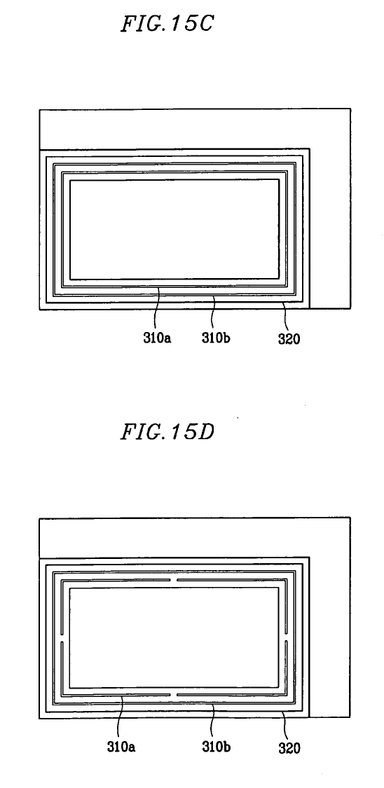

FIGS. 15A to 15D are layout views of a liquid crystal display showing shapes and alignments of the risings 310 according to embodiments of the present invention.

Referring to FIGS. 1 and 15A to 15D, the risings 310 enclose the display region A disposed in a region defined by the sealant 320, and may have continuous protrusion as shown in FIG. 15C or a plurality of protrusions that are discontinuous as shown in FIGS. 15A and 15B or a combination of continuous and discontinuous protrusions as shown in FIG. 15D according to embodiments of the present invention. The risings 310 include an inside rising 310a enclosing the display region A, and an outside rising 310b disposed between the sealant 320 and the inside rising 310a. In an embodiment of the present invention, the risings 310 may have a plurality of folds, and one of the inside and the outside risings 310a and 310b may be omitted.

Because the height of the risings 310 is less than the interval (i.e., cell gap) between two panels 100 and 200, the risings 310 are separated from the thin film transistor array panel 100 by a predetermined gap, and the liquid crystal 300 may be flowed therebetween.

The risings 310 may comprise a material including the components of a light hardening resin or a thermal hardening resin such as, for example, acrylic resin, epoxy resin, acrylic-epoxy resin, and phenol resin. The material for the rising 310 may further include, for example, a photo initiator, a filler, and/or additives.

The thin film transistor panel 100 and the common electrode panel 200 are adhered to each other and combined by the sealant 320. The sealant 320 is formed along the perimeter of the display region A, and is disposed outside the risings 310. The sealant 320 may have a shape of a looped curve and has the same height as the cell gap. The sealant 320 may comprise a material including the components of a light hardening resin or a thermal hardening resin such as, for example, acrylic resin, epoxy resin, acrylic-epoxy resin, and phenol resin.

The liquid crystal 300 is formed in a region enclosed by the sealant 320. The risings 310 formed around the perimeter of the display region A control the velocity of the liquid crystal 300 flowing out from the display region A. Accordingly, the liquid crystal 300 is sufficiently prevented from flowing to the edges of the two panels 100 and 200 such that the cell gap may remain uniform.

The sealant 320 can be hardened by heat or light after aligning the two panels 100 and 200, and the risings 310 prevent the liquid crystal 300 from contacting the sealant 320 wherein the sealant 320 is in an unhardened state. Accordingly, the risings 310 prevent the liquid crystal 300 from being contaminated by the sealant 320 in the unhardened state.

Polarizers (not shown) may be provided on outer surfaces of the panels 100 and 200 such that their polarization axes may cross. One of the polarizers may be omitted when the LCD is a reflective-type LCD.

The liquid crystal layer 3 is formed between the two panels 100 and 200, and includes nematic liquid crystal having positive or negative dielectric anisotropy. The liquid crystal 300 in the LC layer 3 are subjected to a horizontal or vertical alignment in which the liquid crystal 300 are aligned such that their long axes are substantially horizontal or vertical to the surfaces of the panels 100 and 200 in the absence of an electric field.

The LCD may further include a plurality of spacers (not shown) for supporting the two panels 100 and 200 to maintain a uniform cell gap therebetween. The spacers may be, for example, bead spacers in an embodiment of the present invention.

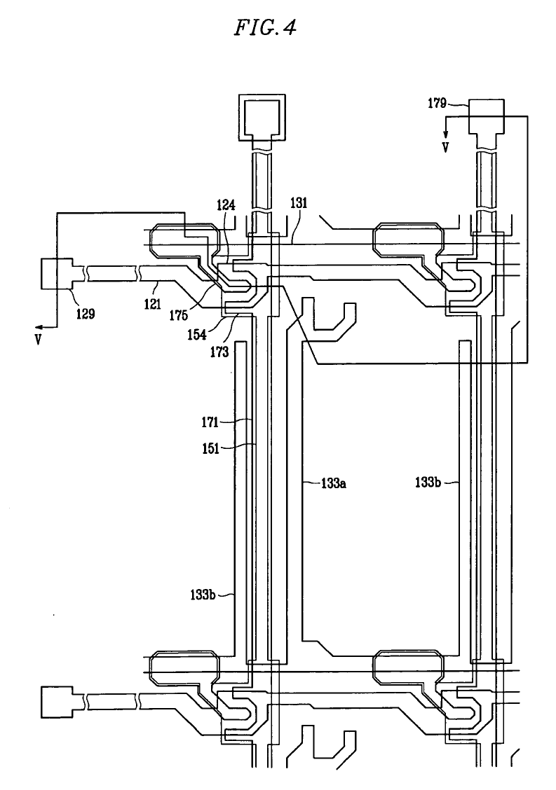

A method of manufacturing the TFT panel 100 of the LCD according to an embodiment of the present invention is described with reference to FIGS. 4 to 10.

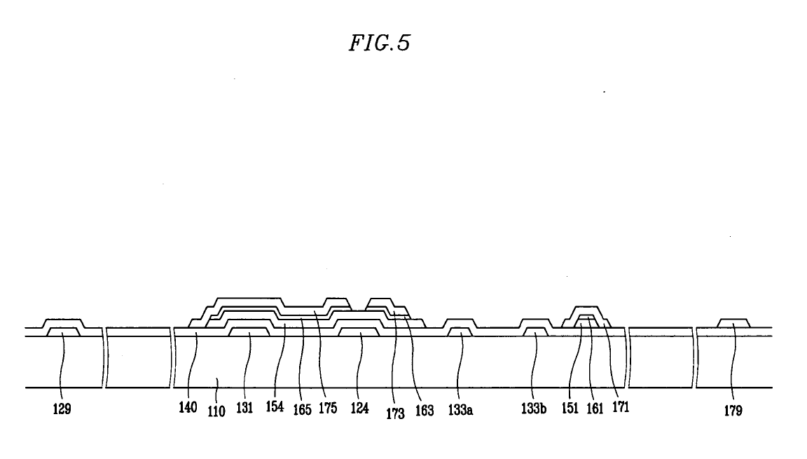

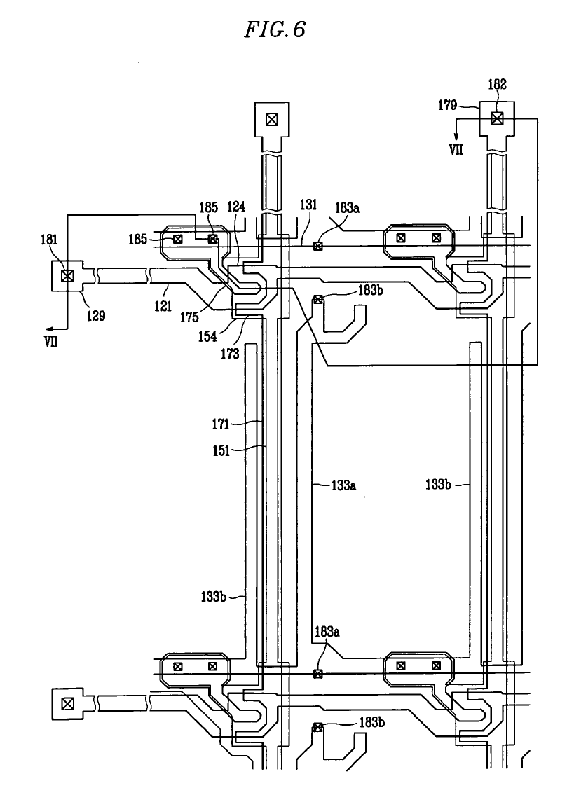

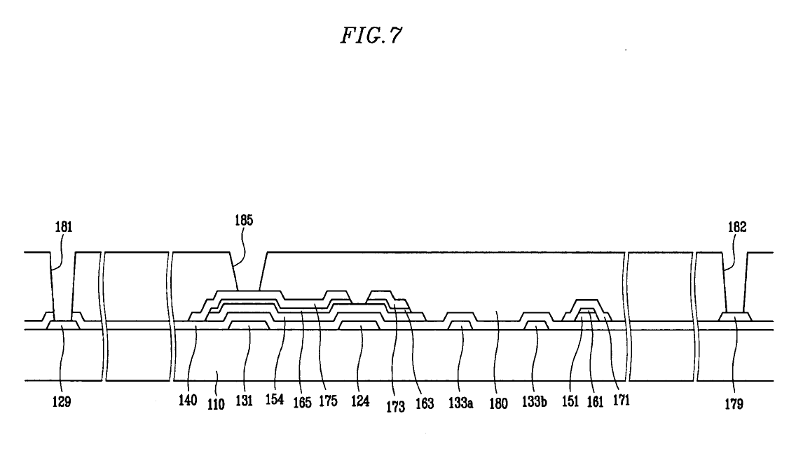

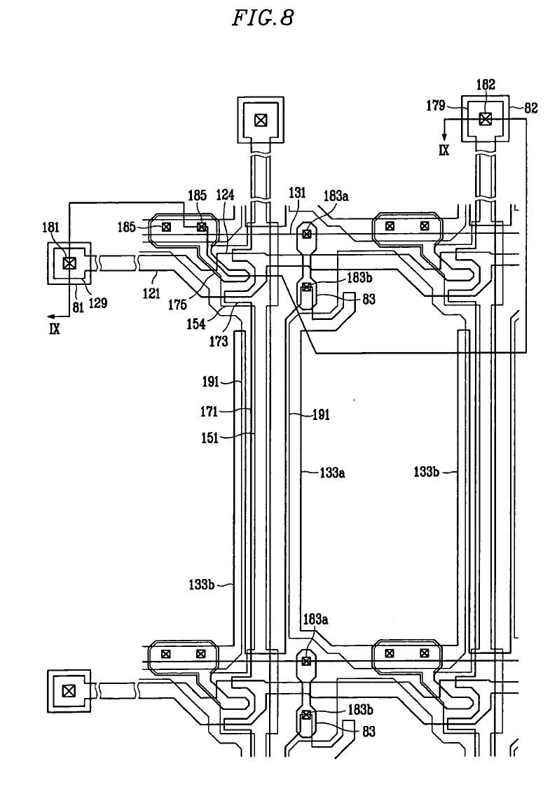

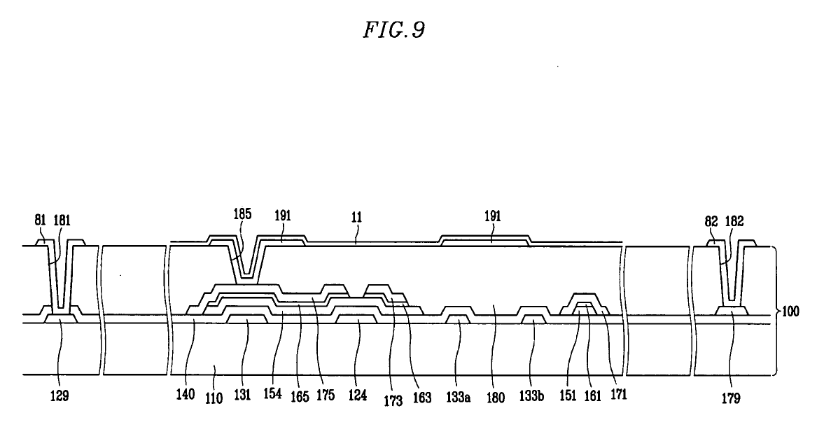

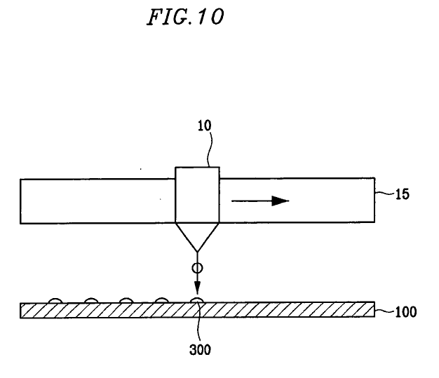

FIG. 4 is a layout view of a TFT array panel for illustrating a manufacturing method of a liquid crystal display according to an embodiment of the present invention. FIG. 5 is a sectional view of a TFT array panel taken along the line V-V in FIG. 4. FIG. 6 is a layout view of a TFT array panel for illustrating a manufacturing process of a liquid crystal display according to an embodiment of the present invention. FIG. 7 is a sectional view of a TFT array panel taken along the line VII-VII in FIG. 6. FIG. 8 is a layout view of a TFT array panel for illustrating a manufacturing process of a liquid crystal display according to an embodiment of the present invention. FIG. 9 is a sectional view of a TFT array panel taken along the line IX-IX in FIG. 8. FIG. 10 is a sectional view of a TFT array panel for illustrating a process for depositing liquid crystal.

Referring to FIGS. 4 and 5, a conductive film of an aluminum alloy is sputtered and patterned by photo-etching with a photoresist pattern to form the plurality of gate lines 121 including the plurality of gate electrodes 124 and the plurality of end portions 129, and the plurality of storage electrode lines 131 including the plurality of storage electrodes 133a and 133b.

After sequential deposition of the gate insulating layer 140, an intrinsic a-Si layer, and an extrinsic a-Si layer, the extrinsic a-Si layer and the intrinsic a-Si layer are photo-etched to form the plurality of extrinsic semiconductors and a plurality of intrinsic semiconductors 154 on the gate insulating layer 140.

A conductive layer of an aluminum alloy is sputtered and is etched using a photoresist film (not shown) to form the plurality of data lines 171 including the plurality of source electrodes 173, and the plurality of drain electrodes 175.

Portions of the extrinsic semiconductors, which are not covered with the data lines 171, and the drain electrodes 175, are removed by etching to form the plurality of ohmic contacts 163 and 165 and to expose portions of the intrinsic semiconductors 154.

Referring to FIGS. 6 and 7, the passivation layer 180 is deposited or coated, and is then etched along with the gate insulating layer 140 to form the plurality of contact holes 181, 182, 183a, 183b, and 185.

A conductive layer comprising, for example, a transparent material such as ITO and IZO is deposited by, for example, sputtering, and is etched using the photoresist as an etch mask to form the plurality of pixel electrodes 190, the plurality of contact assistants 81 and 82, and the plurality of overpasses 83. Then, the alignment layer 11 is coated on the pixel electrodes 191 to complete the thin film transistor panel 100.

A plurality of spacers (not shown) are formed on the thin film transistor panel 100. The spacers may be bead spacers that are dispersed with a uniform distribution on the thin film transistor panel 100 by using, for example, a spacer disperser according to an embodiment of the present invention.

The liquid crystal 300 is deposited on the thin film transistor panel 100 by using, for example, a liquid crystal depositor 10. The liquid crystal depositor 10 is attached at a position controller 15 and deposits the liquid crystal 300 at the predetermined positions on the thin film transistor panel 100 with motion in upward, downward, right, and left directions.

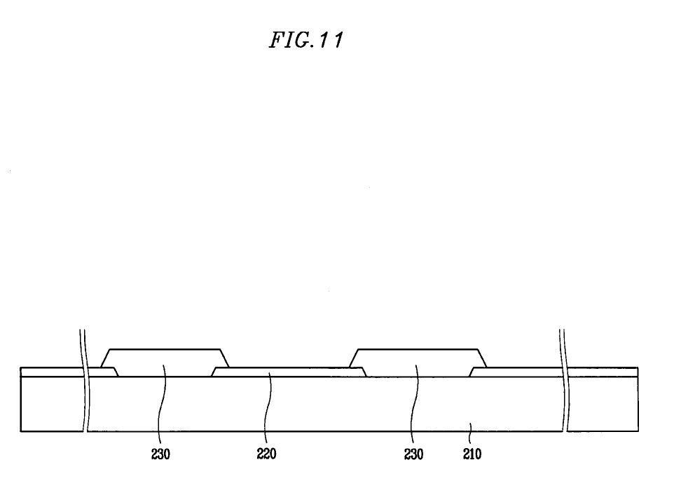

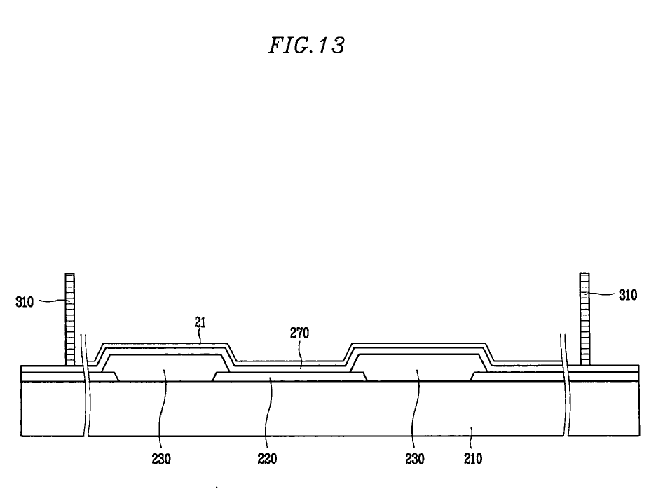

A method of manufacturing the common electrode panel 200 of the LCD according to an embodiment of the present invention is described with reference to FIGS. 11 to 14.

FIGS. 11 to 14 are sectional views of the common electrode panel 200 for illustrating a manufacturing method of an LCD according to an embodiment of the present invention.

Referring to FIG. 11, the light blocking member 220 comprising an opaque material is formed on an upper insulating substrate 210 comprising a material such as, for example, transparent glass. Pluralities of color filters 230 are formed on the insulating substrate 210. A photosensitive pigment dispersion resin having color spectrum characteristics may be coated on the upper insulating substrate 210 and the resin layer may be photo-etched, or an inkjet printing method may be used to form the color filters 230 of red, green, and blue.

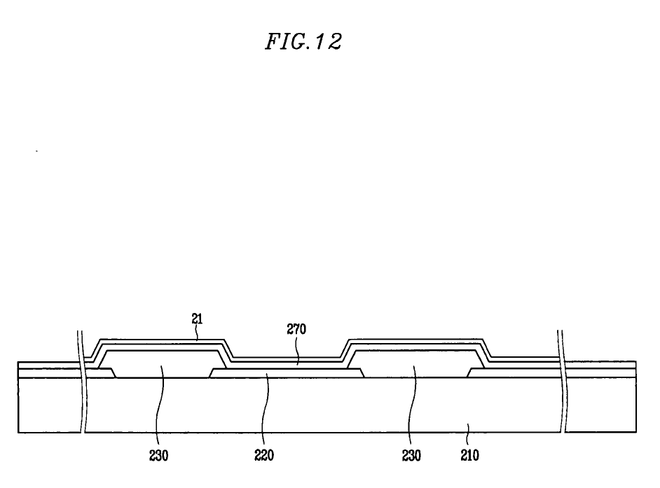

Referring to FIG. 12, the common electrode 270 comprising a transparent conductive material such as, for example, ITO is formed on the color filters 230 and the light blocking member 220. Then, the second alignment layer 21 is coated on the common electrode 270.

Then, the plurality of risings 310 can be formed outside the display region A on the common electrode panel 200. The risings 310 are coated to enclose the perimeter of the display region A by using, for example, a dispenser. The height and width of the risings 310 may be controlled according to the injection amount of the dispenser. According to an embodiment of the present invention, the height of the risings 310 can be less than the cell gap of the LCD. Thus, the risings 310 may be formed without an additional mask.

The risings 310 can be hardened using, for example, the radiation of ultra violet rays. According to an embodiment of the present invention, the polymer resin is hardened through the reaction of the photo initiator of the risings 310. A thermal hardening process may be performed in addition to the radiation of ultra violet rays according to an embodiment of the present invention. The thermal hardening process is executed at a temperature of about 12□ for about 60 minutes to completely harden the remaining polymer resin of the risings 310.

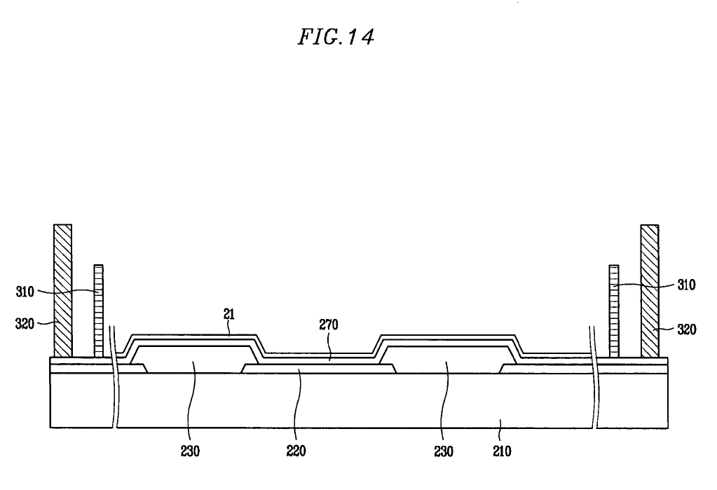

Referring to FIG. 14, the sealant 320 is formed outside the region enclosed by the risings 310. The sealant 320 is coated to enclose the circumference of the risings 310 by using the dispenser. The height and width of the sealant 320 may be controlled according to the injection amount of the dispenser. According to an embodiment of the present invention, the height of the sealant 320 can be equal to or larger than the cell gap upon the consideration of the pressure applied to the two panels 100 and 200.

According to an embodiment of the present invention, the thin film transistor panel 100 and the common electrode panel 200 can be assembled in a vacuum atmosphere.

The sealant 320 between the thin film transistor panel 100 and the common electrode panel 200 can be hardened by the radiation of ultra violet rays. According to an embodiment of the present invention, the thermal hardening process may be performed.

In an embodiment of the present invention, the liquid crystal 300 is deposited on the thin film transistor array panel 100, and the risings 310 and the sealant 320 are formed on the common electrode panel 200. In an embodiment of the present invention, the liquid crystal 300 may be deposited on the common electrode panel 200, the risings 310 and the sealant 320 may be formed on the thin film transistor array panel 100. In an embodiment of the present invention, the liquid crystal 300, the risings 310, and the sealant 320 may be formed on the same panel.

According to an embodiment of the present invention, the risings 310 are formed between the sealant 320 and the display region A. Thus, the liquid crystal 300 can be prevented from flowing to edges of the two panels 100 and 200 such that the cell gap may remain uniform. Furthermore, the risings 310 prevent the liquid crystal 300 from contacting the sealant 320 in the unhardened state before combining the two panels 100 and 200. Accordingly, the risings 310 prevent the liquid crystal 300 from being contaminated by the sealant 320 wherein the sealant 320 is in the unhardened state. Also, the risings 310 can be formed with the same process used for forming the sealant 320 without an additional mask.

Although exemplary embodiments have been described with reference to the accompanying drawings, it is to be understood that the present invention is not limited to these precise embodiments but various changes and modifications can be made by one skilled in the art without departing from the spirit and scope of the present invention. All such changes and modifications are intended to be included within the scope of the invention as defined by the appended claims.

What is claimed is:

1. A liquid crystal display comprising:
first and second panels facing each other;
a sealant disposed between the first and second panels and formed along a perimeter of one of the first and second panels;
a rising disposed on the same panel as the sealant formed on and formed along at least a portion of the perimeter of a display region enclosed by the sealant; and
a liquid crystal layer enclosed by the sealant and disposed between the first and second panels.

2. The liquid crystal display of claim 1, wherein a height of the rising is less than a height of the sealant.

3. The liquid crystal display of claim 1, wherein the rising includes a plurality of discontinuous protrusions.

4. The liquid crystal display of claim 1, wherein the rising includes a first rising and a second rising, the second rising being formed between the first rising and the sealant.

5. The liquid crystal display of claim 1, wherein the rising comprises one of acrylic resin, epoxy resin, acrylic-epoxy resin, or phenol resin.

6. The liquid crystal display of claim 1, further comprising a plurality of spacers disposed between the first and second panels.

7. A liquid crystal display comprising:
first and second panels facing each other;
a sealant disposed between the first and second panels and formed along a perimeter of one of the first and second panels;
a rising disposed on the same panel as the sealant formed on and formed along at least a portion of the perimeter of a display region enclosed by the sealant;
a plurality of spherical spacers disposed between the first and second panels; and
a liquid crystal layer enclosed by the sealant and disposed between the first and second panels.

8. The liquid crystal display of claim 7, wherein a height of the rising is less than a height of the sealant.

9. The liquid crystal display of claim 7, wherein the rising includes a plurality of discontinuous protrusions.

10. The liquid crystal display of claim 7, wherein the rising includes a first rising and a second rising, the second rising being formed between the first rising and the sealant.

11. The liquid crystal display of claim 7, wherein the rising includes a thermal hardening material or a light hardening material.

12. A method for manufacturing a liquid crystal display, comprising:
forming first and second panels having a plurality of thin films;
forming a rising on one of the first and second panels;
hardening the rising;
forming a sealant enclosing the rising on one of the first and second panels;
assembling the first panel and the second panel; and
hardening the sealant.

13. The method of claim 12, wherein a height of the rising is less than a height of the sealant.

14. The method of claim 12, further comprising:
forming an alignment layer on the same panel as the rising formed on before forming the plurality of risings.

15. The method of claim 12, wherein the rising includes a first rising and a second rising, the second rising being formed between the first rising and the sealant.

16. The method of claim 12, wherein hardening the rising and the sealant are executed by using one of light irradiation or thermal irradiation.

17. The method of claim 12, wherein forming the first panel includes:
forming a gate line on a first substrate;
forming a semiconductor on the gate line;
forming a data line intersecting the gate line and a drain electrode; and
forming a pixel electrode connected to the drain electrode.

18. The method of claim 17, further comprising:
depositing liquid crystal on the first panel after forming the first panel.

19. The method of claim 18, further comprising:
dispersing a plurality of spacers on the first panel after forming the first panel.

20. The method of claim 17, wherein forming the second panel includes:
forming a light blocking member on a second substrate;
forming a color filter on the second substrate; and
forming a common electrode on the light blocking member and the color filter.

21. The method of claim 12, wherein the first and second panels are assembled in a vacuum atmosphere.
